(19) United States
(12) Patent Application Publication
(10) Pub. No.: US 2004/0010587 A1
(43) Pub. Date: Jan. 15, 2004

(54) Method and apparatus for displaying real time graphical and digital wellbore information responsive to browser initiated client requests via the internet

(76) Inventors: Arturo Altamirano, Fresno, TX (US); MARTI K SRINAGESH, STAFFORD, TX (US)

Correspondence Address: SCHLUMBERGER TECHNOLOGY CORPORATION, IP DEPT., WELL STIMULATION, 110 SCHLUMBERGER DRIVE, MD1, SUGAR LAND, TX, 77478, US

(21) Appl. No.: 10/208,765

(22) Filed: Jul. 30, 2002

Related U.S. Application Data
(60) Provisional application No. 60/394,697, filed on Jul. 9, 2002.

(51) Int. Cl. G06F 15/173; G01V 3/00

(52) U.S. Cl. 709/224; 340/853.1

(57) ABSTRACT

An interactive (‘InterACT’) apparatus and associated method will transmit wellbore information, in real time, to a client approximately simultaneously with a generation of the wellbore information at a well site, in response to interactive requests made by the client at a workstation computer over the internet, without requiring the client to actually travel to the well site in order to acquire and view the wellbore information. In addition, the interactive apparatus and associated method will generate and display, on a client's display screen of the client's personal computer or workstation, a unique ‘display window’ (known as the ‘InterACT Stimulation Viewer’) when the client is accessing the internet using only the client's ‘browser’ software that is already installed on the client's personal computer (such as, Netscape Navigator or Microsoft Internet Explorer). As a result, there is no need to purchase or license any additional software, other than the ‘browser software’, to display the unique ‘display window’ on the client's display screen of his personal computer. The new and novel ‘display window’ displays ‘real-time’ wellbore information to the client approximately simultaneously with the generation of that wellbore information at the well site, the ‘display window’ displaying both ‘real-time’ digital ‘wellbore data’ information and ‘real-time’ graphical ‘wellbore data’ information (which can utilize the digital information to generate the graphical format) for displaying the ‘real-time’ wellbore information.

### CROSS REFERENCE TO RELATED APPLICATIONS

This is a Utility application of prior pending Provisional patent application serial No. 60/394,697, filed Jul. 9, 2002, and entitled “Interact Stimulation Viewer”.

### BACKGROUND OF THE INVENTION

The subject matter of the present invention relates to a method and apparatus for generating a display of wellbore information acquired in real time in response to interactive requests generated by a client at a workstation over the internet, the displayed wellbore information being acquired approximately simultaneously with the generation of such information at a remote well site without requiring the client to travel to the well site to acquire and view such wellbore information.

When wellbore information is generated at a remote well site, it is difficult to transmit the wellbore information to a potential client when the client is located hundreds or perhaps thousands of miles away from the well site. In the past, if the client wanted to acquire and view the wellbore information in real time, it was necessary for the client to travel to the well site in order to view that information. However, such travel is inconvenient and stressful and expensive for the client. Therefore, an apparatus and associated method is needed which will actually transmit the wellbore information to the client approximately simultaneously with the generation of the wellbore information at the well site without also requiring the client to actually travel to the well site in order to acquire and view that wellbore information.

In addition, the internet has opened up new methods for communicating information to the public. Since the aforementioned apparatus and associated method is needed for transmitting wellbore information to a client approximately simultaneously with the generation of that wellbore information at a well site without also requiring the client to actually travel to the well site in order to acquire and view that wellbore information, an interactive apparatus and associated method is needed which utilizes the internet in order to provide that wellbore information to the client, in real time.

If the interactive apparatus and associated method, which utilizes the internet, were developed, a need exists to generate and display a unique ‘display window’ on a client's personal computer or workstation processor when that client is accessing the internet using only the ‘browser’ software already installed on the client's personal computer, where the ‘display window’ displays ‘wellbore data’ and information to the client, in real time, approximately simultaneously with the generation of that ‘wellbore data’ information at the well site.

### SUMMARY OF THE INVENTION

Accordingly, an interactive apparatus and associated method (hereinafter called the “InterACT method and apparatus”) will transmit wellbore information, in real time, to a client approximately simultaneously with a generation of the wellbore information at a well site, in response to interactive requests made by the client at a workstation computer over the internet, without requiring the client to actually travel to the well site in order to acquire and view the wellbore information. In addition, the interactive apparatus and associated method will generate and display, on a client's display screen of the client's personal computer or workstation, a unique ‘display window’ (formally known as the ‘InterACT Stimulation Viewer’) when the client is accessing the internet using only the client's ‘browser’ software that is already installed on the client's personal computer (such as, Netscape Navigator or Microsoft Internet Explorer). As a result, there is no need to purchase or license any additional software, other than the ‘browser software’, to display the unique ‘display window’ on the client's display screen of his personal computer. The new and novel ‘display window’ displays ‘real-time’ wellbore information to the client approximately simultaneously with the generation of that wellbore information at the well site, the ‘display window’ displaying both real-time digital ‘wellbore data’ information and real-time graphical ‘wellbore data’ information (which can utilize the digital information to generate the graphical format) for displaying the ‘real-time’ wellbore information.

The InterACT method and apparatus includes a primary “InterACT” server. A well logging truck located at a remote well site transmits wellbore data signals to either a satellite or to a land tower via a cell phone, the wellbore data signals being retransmitted from the satellite or land tower to the primary “InterACT” server, which could be located hundreds or thousands of miles away from the remote well site. Since the wellbore data signals carry and store ‘wellbore data’ therein, the primary “InterACT” server responds to the received wellbore data signals by storing the ‘wellbore data’, which is inherent in the wellbore data signals, in a secondary server. However, while the wellbore data signals are stored in the secondary server, an applet software program is stored in the primary “InterACT” server, the applet software program being uniquely associated with the ‘wellbore data’ that has been stored in said secondary server. A client at a workstation computer uses his ‘browser’ (e.g., Netscape Communicator or Microsoft Internet Explorer) to interrogate the internet for the purpose of accessing the primary “InterACT” server. When the client accesses the primary server via the internet, the client requests, from the primary “InterACT” server, a ‘catalog of wellbore information’. In response to the client's request, the primary server sends the ‘catalog of wellbore information’ back to the client's workstation computer via the internet. The client, sitting at his workstation computer, reads the ‘catalog of wellbore information’. One of the entries in the ‘catalog of wellbore information’ includes certain ‘wellbore data’. The client requests the ‘wellbore data’ entry in the ‘catalog of wellbore information’ by clicking on the ‘wellbore data’ entry in the ‘catalog’. Recall that the ‘wellbore data’ in the ‘catalog of wellbore information’ is stored in the secondary server. As a result of the client's request for the ‘wellbore data’ in the ‘catalog’, a second request is transmitted from the client's workstation computer, via the internet, to the primary “InterACT” server. The primary server retrieves the ‘wellbore data’ from the secondary server. Recalling that the primary server stores therein the ‘applet’ software program which is uniquely associated with the ‘wellbore data’, when the primary “InterACT” server receives the ‘wellbore data’ from the secondary server, the primary server transmits both the ‘applet’ software program and the ‘wellbore data’ back to the client's workstation computer, via the internet. When the client's workstation computer receives the ‘applet’ software program and the ‘wellbore data’ from the primary server, since the client's workstation computer stores a ‘browser’ (such as Netscape Communicator or Microsoft Internet Explorer), the client's ‘browser’ automatically executes the ‘applet’ software program. During the execution of the ‘applet’ software program by the client's browser, the ‘wellbore data’ is utilized during the execution of the ‘applet’. When the client's browser completes the execution of the ‘applet’ using the ‘wellbore data’, a new and novel ‘display window’, called the “InterACT Stimulation Viewer”, is generated. The ‘InterACT Stimulation Viewer display window’ (which is illustrated in FIG. 21) displays the ‘wellbore data’ in real time; that is, the ‘display window’ displays the ‘wellbore data’ approximately simultaneously with the generation of the ‘wellbore data’ by the well logging truck at the remote well site. The client need not travel to the remote well site to view the ‘wellbore data’. Instead, the client need only view the ‘wellbore data’ at his workstation computer via the internet (in the comfort of his home or office) because the ‘wellbore data’ is being displayed on the ‘display window’ approximately simultaneously with the generation of the ‘wellbore data’ at the remote well site. The InterACT Stimulation Viewer is accessable and viewable over the internet and it includes a plurality of digital information (e.g., treatment pressure, slurry rate, proppant concentration, etc) and graphical information. In the graphical information, there are three different plots which are accessable and viewable by a client: a Pressure-Rate-Concentration or Density (PRC) plot which measures treatment pressure, the rate at which the treatment is accomplished, and the concentration or density of the fluid; a User plot which will display the digital information in a graphical format (e.g., annulus pressure vs. time); and a Nolte-Smith plot which is a computation that takes into account the bottom hole pressure. The Nolte-Smith plot reveals how a reservoir is reacting to a fracture treatment, i.e., how well the fracture treatment is being accomplished. In particular, the InterACT Stimulation Viewer is accessible and viewable by a client without the need to install any software on a client's personal computer. As long as the client can access the internet, the InterACT Stimulation Viewer is accessible and viewable by the client.

Further scope of applicability of the present invention will become apparent from the detailed description presented hereinafter. It should be understood, however, that the detailed description and the specific examples, while representing a preferred embodiment of the present invention, are given by way of illustration only, since various changes and modifications within the spirit and scope of the invention will become obvious to one skilled in the art from a reading of the following detailed description.

### BRIEF DESCRIPTION OF THE DRAWINGS

A full understanding of the present invention will be obtained from the detailed description of the preferred embodiment presented hereinbelow, and the accompanying drawings, which are given by way of illustration only and are not intended to be limitative of the present invention, and wherein:

FIGS. 1 through 4 illustrate an interactive apparatus and associated method (hereinafter called the “InterACT method and apparatus”) for transmitting wellbore information, in real time, to a client approximately simultaneously with a generation of the wellbore information at a well site, in response to interactive requests made by the client at a workstation computer over the internet, without requiring the client to actually travel to the well site in order to acquire and view the wellbore information, the interactive apparatus of FIGS. 1 through 4 further including,

FIG. 1 which illustrates how a well logging truck will transmit wellbore data signals over a satellite or over a land tower to a remote receiving location,

FIG. 2 which illustrates a detailed construction of the remote receiving location of FIG. 1 which includes a primary server, and

FIGS. 3, 3A, and 4 which illustrate the contents of the primary server and a secondary server in the detailed construction of FIG. 2;

FIG. 5 illustrates a construction of a client's workstation or personal computer before the applet software and the wellbore data of FIGS. 3 and 4 have been downloaded into a memory of the client's computer, the memory storing a browser software;

FIGS. 6 through 11 illustrate different views of the detailed construction of FIG. 2, such different views depicting a functional operation of the client's workstation, internet, primary server, and a secondary server in the detailed construction of the receiving location of FIG. 2;

FIG. 12 illustrates a construction of a client's workstation or personal computer after the applet software and the wellbore data of FIGS. 3 and 4 have been downloaded into a memory of the client's computer, the memory storing the browser software and the applet software and the wellbore data;

FIG. 13 illustrates the new and novel ‘display window’ or ‘InterACT Stimulation Viewer’ of the present invention which is generated in the client's workstation when a received ‘applet’ is executed using received ‘wellbore data’, the ‘display window’ displaying, in real time, the ‘wellbore data’ approximately simultaneously with the generation of the ‘wellbore data’ at a remote well site;

FIGS. 14 through 20 illustrate an overview of a basic operation of an InterACT stimulation service, as described above with reference to FIGS. 2 through 13,

FIG. 14 illustrating logging in, querying the server, responses from the server, file selection, and file delivery,

FIG. 15 illustrating a login page,

FIG. 16 illustrating a well level page, representing a ‘catolog of wellbore information’,

FIG. 17 illustrating a ‘save file’ dialog wherein a downloaded applet and wellbore data can be saved in a particular file on a client's workstation or personal computer,

FIG. 18 illustrating a launch applet dialog which requests permission to launch the downloading of an applet,

FIG. 19 illustrating the download status of the applet when a request to download the applet in FIG. 18 is granted, and

FIG. 20 illustrating the fact that step 5 in FIG. 14 (return file and RDV applet) has been completed;

FIG. 21 illustrates the new and novel ‘display window’, formally referred to as the ‘InterACT Stimulation Viewer’, of FIG. 13; and

FIG. 22 illustrates a detailed construction of the ‘applet’ which is executed by the client's browser in conjunction with the ‘wellbore data’.

### DETAILED DESCRIPTION

Referring to FIGS. 1 through 4, an interactive apparatus and associated method (hereinafter called the ‘InterACT method and apparatus’) is illustrated. The ‘InterACT method and apparatus’ transmits ‘wellbore data’, in real time, from a remote well site to a remotely located client approximately simultaneously with a generation of the wellbore information at the remote well site, in response to interactive requests made by the client at a workstation computer over the internet. As a result, it is no longer necessary for the client to actually travel to the remotely-located well site in order to acquire and view the ‘wellbore data’. In addition, a novel ‘display window’ will be generated, called the ‘InterACT Stimulation Viewer’, which will display real time ‘wellbore data’ for the remotely located client when the client is accessing the internet, the ‘display window’ displaying both digital ‘wellbore data’ information and graphical ‘wellbore data’ information which utilizes the digital ‘wellbore data’ information during the graphical process.

In FIG. 1, a well logging truck 10 transmits ‘wellbore data signals’ to either a satellite 12 or to a land tower 14 via cellular telephone, the satellite 12 or land tower 14 retransmitting the ‘wellbore data signals’ to a remote receiving location 16. The remote receiving location 16 could be hundreds or thousands of miles away from the well logging truck 10.

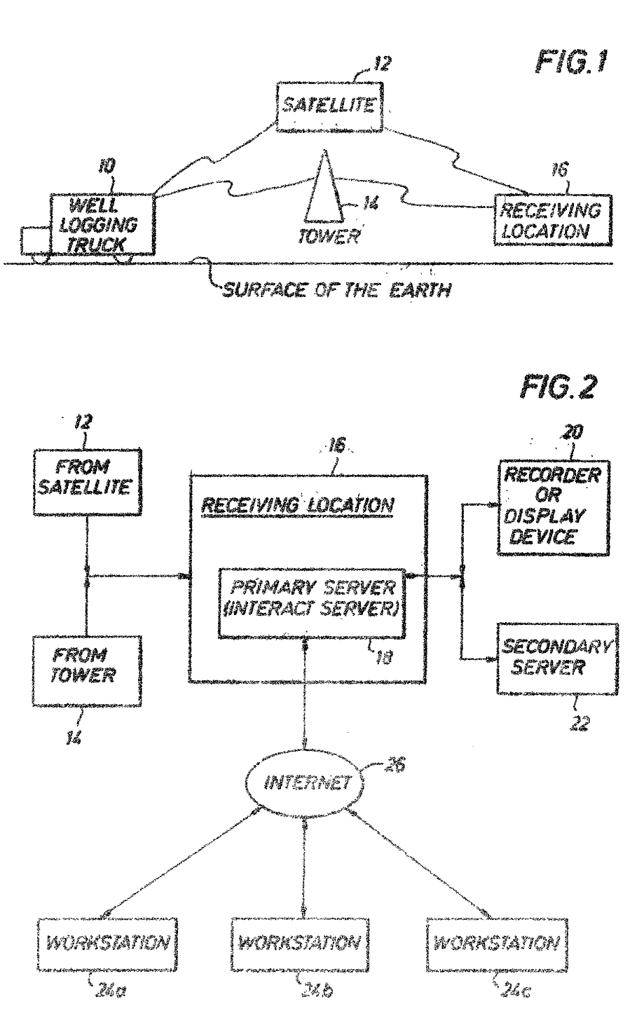

In FIG. 2, a detailed construction of the receiving location 16 is illustrated. In FIG. 2, the remote receiving location 16 includes a primary server 18, also called an “InterACT” server 18, where the word “InterACT” refers to the word ‘Interactive’ in view of the interactive nature of the system in this specification which we are about to discuss. The primary server 18 is operatively connected to a recorder or display device 20. In addition, the primary server 18 is also operatively connected to a secondary server 22 (in FIG. 11, the back end database 37 is the secondary server 22). A plurality of workstations 24a, 24b, and 24c are operatively connected to the primary “InterACT” server 18 via the ‘Internet’ 26.

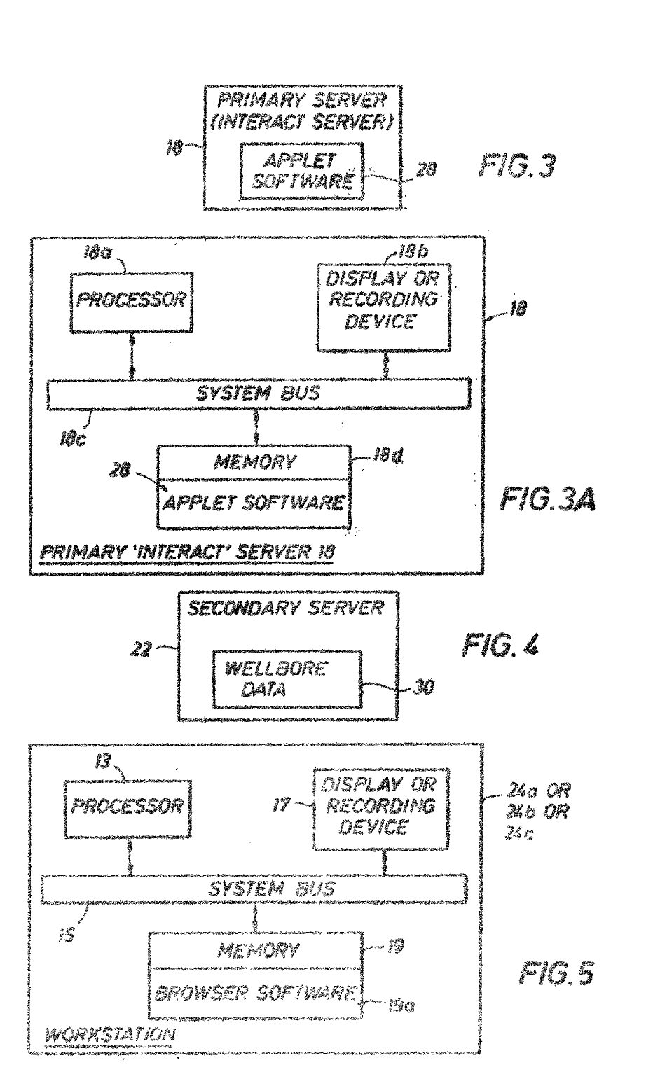

In FIG. 3, a construction of the primary ‘InterACT’ server 18 of FIG. 2 is illustrated. In FIG. 3, the primary server 18 stores a software program therein which is hereinafter known as an ‘applet’ software program 28.

In FIG. 3A, a more detailed construction of the primary ‘InterACT’ server 18 of FIG. 3 is illustrated. In FIG. 3A, the primary server 18 includes a processor 18a connected to a system bus 18c, a display or recording device 18b connected to the system bus 18c, and a memory 18d connected to the system bus 18c, the memory 18d storing the ‘applet’ software program 28 of FIG. 3. The memory 18d is a computer readable medium or a program storage device which is readable by a machine, such as the processor 18a. The processor 18a may be, for example, a microprocessor, microcontroller, or a mainframe or workstation processor. The memory 18d, which stores the ‘applet’ software program 28, may be, for example, a hard disk, ROM, CD-ROM, DRAM, or other RAM, flash memory, magnetic storage, optical storage, registers, or other volatile and/or non-volatile memory.

In FIG. 4, a-more detailed construction of the secondary server 22 of FIG. 2 is illustrated. In FIG. 4, the secondary server 22 stores therein certain ‘wellbore data’ 30 which is associated with the ‘applet’ software program 28 stored in the primary server 18.

Referring to FIG. 5, a construction of each of the workstation computers or personal computers 24a, 24b, and 24c of FIG. 2 (belonging to a client) is illustrated, at a time before the applet software 28 of FIG. 3 and the wellbore data 30 of FIG. 4 has been downloaded into the workstation computers 24a-24c. In FIG. 5, each workstation 24a-24c includes a processor 13 connected to a system bus 15, a display or recording device 17 connected to the system bus 15, and a memory 19 connected to the system bus 15, where the memory stores a browser software 19A therein. The memory 19 is a computer readable medium or a program storage device which is readable by a machine, such as the processor 13. The processor 13 may be, for example, a microprocessor, microcontroller, or a mainframe or workstation processor. The memory 19 may be, for example, a hard disk, ROM, CD-ROM, DRAM, or other RAM, flash memory, magnetic storage, optical storage, registers, or other volatile and/or non-volatile memory.

Referring to FIGS. 6 through 13, a functional description of the operation of the “InterACT method and apparatus” of FIGS. 1 through 4 is set forth in the following paragraphs with reference to FIGS. 6 through 13. Recall that the InterACT method and apparatus of FIGS. 1 through 4 of the present invention transmits ‘wellbore data’, in real time, from a remotely-located well site to a client (located hundreds or thousands of miles away from the remote well site) approximately simultaneously with a generation of the wellbore information at the remote well site, and that a new and novel ‘display window’ is generated which displays that ‘wellbore data’ in real time. As a result, it is not necessary for the client to travel to the remote well site to acquire, view and consider the aforementioned ‘wellbore data’.

A well logging truck 10 located at a remote well site transmits wellbore data signals to either a satellite 12 or to a land tower 14 via a cell phone, the wellbore data signals being retransmitted from the satellite 12 or land tower 14 to the primary “InterACT” server 18, which could be located hundreds or thousands of miles away from the remote well site. Since the wellbore data signals carry and store ‘wellbore data’ therein, the primary “InterACT” server 18 responds to the received wellbore data signals by storing the ‘wellbore data’, which is inherent in the wellbore data signals, in the secondary server 22. However, while the wellbore data signals are stored in the secondary server 22, an applet software program 28 is stored in the primary “InterACT” server 18, the applet software program 28 being uniquely associated with the ‘wellbore data’ that has been stored in the secondary server 22.

In FIG. 6, a client at a workstation computer 24a uses his ‘browser’ 19A (e.g., Netscape Communicator or Microsoft Internet Explorer) to interrogate the internet 26 for the purpose of accessing the primary “InterACT” server 18. When the client accesses the primary server 18 via the internet 26, the client requests, from the primary “InterACT” server 18, a ‘catalog of wellbore information’.

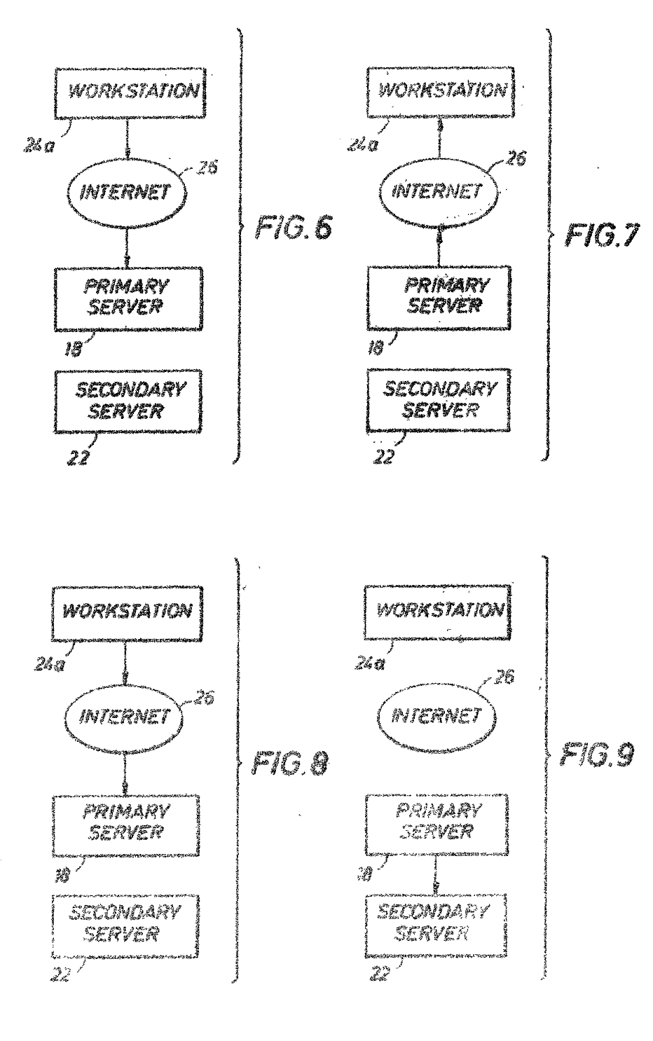

In FIG. 7, in response to the client's request, the primary server 18 sends the ‘catalog of wellbore information’ back to the client's workstation computer 24a via the internet 26. The client, sitting at his workstation computer, reads the ‘catalog of wellbore information’. One of the entries in the ‘catalog of wellbore information’ includes certain ‘wellbore data’.

In FIG. 8, the client at his workstation or personal computer 24a requests the ‘wellbore data’ entry in the ‘catalog of wellbore information’ by clicking on the ‘wellbore data’ entry in the ‘catalog’. Recall that the ‘wellbore data’ 30 in the ‘catalog of wellbore information’ is stored in the secondary server 22. As a result of the client's request for the ‘wellbore data’ in the ‘catalog’, a second request is transmitted from the client's workstation computer 24a, via the internet 26, to the primary “InterACT” server 18.

In FIG. 9, the primary server 18 locates the ‘wellbore data’ 30 that is stored in the secondary server 22.

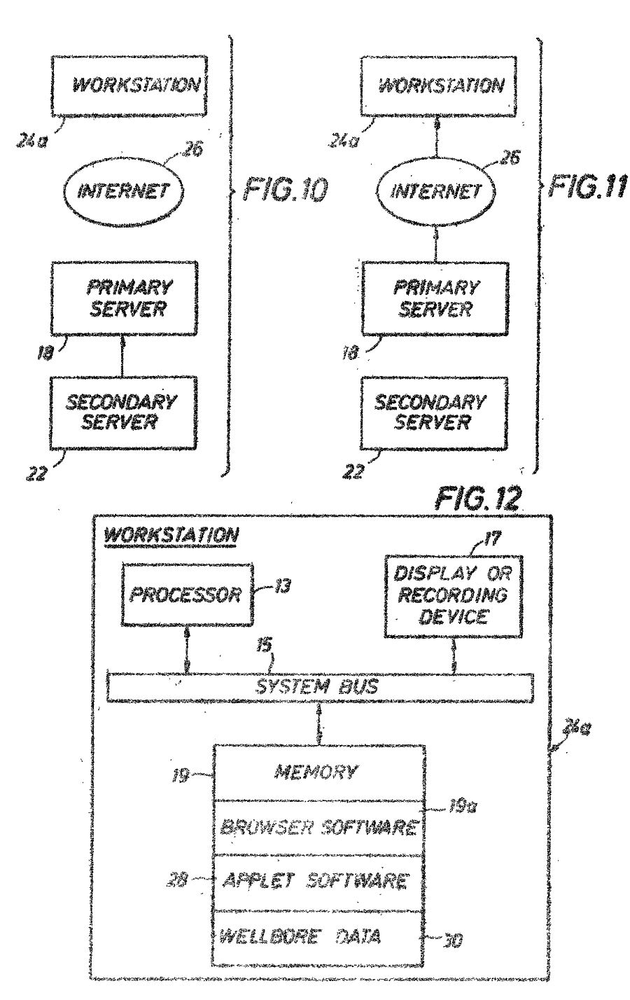

In FIG. 10, the primary server 18 retrieves the ‘wellbore data’ 30 that is stored in the secondary server 22 and temporarily stores the ‘wellbore data’ 30 in the primary server 18.

In FIG. 11, recalling that the primary server 18 stores therein the ‘applet’ software program 28 which is uniquely associated with the ‘wellbore data’ 30, when the primary server 18 receives the ‘wellbore data’ 30 from the secondary server 22 and stores the ‘wellbore data’ therein, the primary server 18 then transmits both the ‘applet’ software program 28 and the associated ‘wellbore data’ 30 from the primary server 18 to the client's workstation computer 24a, via the internet 26.

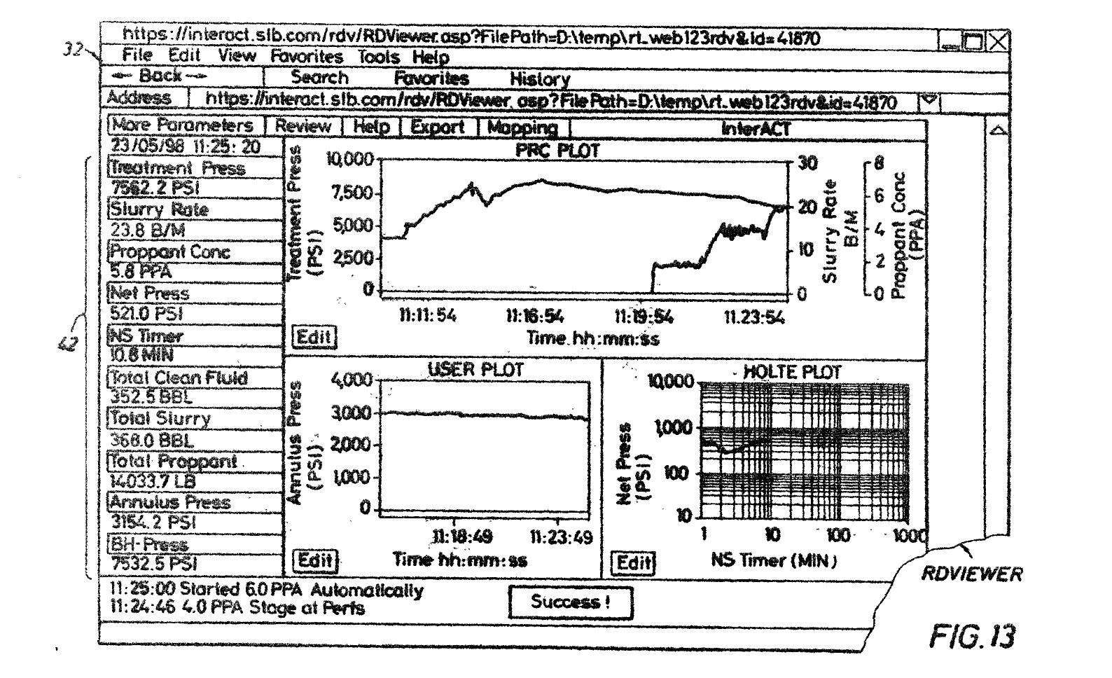

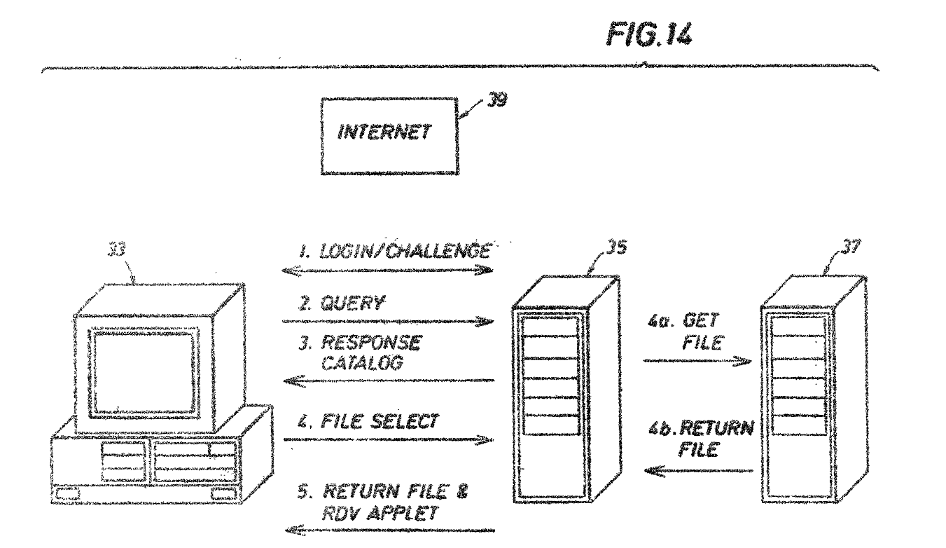

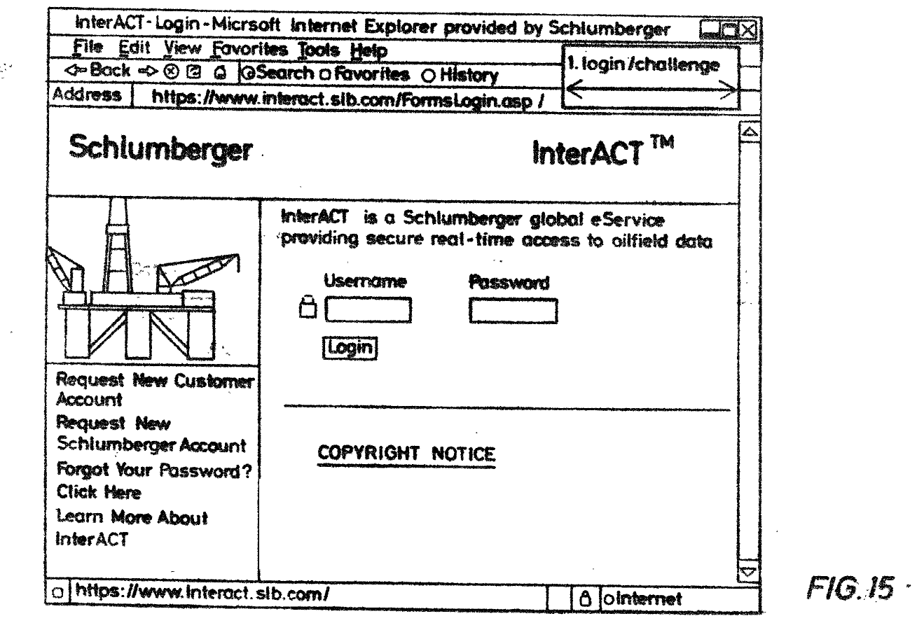

In FIG. 12, when the client's workstation computer 24a, in FIG. 12, receives the ‘applet’ software program 28 and the associated ‘wellbore data’ 30 from the primary server 18, the processor 13 of the workstation 24a will store both the received ‘applet’ software 28 and the received ‘wellbore data’ 30 in the memory 19 of the workstation 24a. Now, the memory 19 of the workstation 24a in FIG. 12 stores: (1) the ‘browser’ software 19A, (2) the ‘applet’ software 28, and (3) the ‘wellbore data’ 30. Since the memory 19 of workstation computer 24a already stores the ‘browser’ software 19A in the memory 19 (such as Netscape Communicator or Microsoft Internet Explorer), the client's ‘browser’ 19A automatically executes the ‘applet’ software program 28, and, during that execution of the ‘applet’ software 28 by the ‘browser’ 19A, the ‘wellbore data’ 30 is utilized. When the client's ‘browser’ 19A completes the execution of the ‘applet’ software program 28 while using the associated ‘wellbore data’ 30, a new and novel ‘display window’ 32 is generated and displayed on the display screen of the ‘display or recording device’ 17 of the client's workstation or personal computer 24a. The new and novel ‘display window’ 32, formally known as the “InterACT Stimulation Viewer” 32, is illustrated in FIG. 13.

In FIG. 13, the aforementioned new and novel ‘display window’ 32/InterACT Stimulation Viewer 32, that is being displayed on the display screen of the ‘display or recording device’ 17 of the client's workstation or personal computer 24a, displays the ‘wellbore data’ 30 in real time; that is, the ‘display window’ 32 displays the ‘wellbore data’ 30 approximately simultaneously with the generation of the ‘wellbore data’ 30 by the well logging truck 10 at the remote well site. The client need not travel to the remote well site to view the ‘wellbore data’ 30. Instead, the client need only view the ‘wellbore data’ 30 in the comfort of his/her home or office at his workstation or personal computer 24a, via the internet 26, because the ‘wellbore data’ 30 is being displayed on the ‘display window’ 32 of FIG. 13 approximately simultaneously with the generation of that ‘wellbore data’ 30 at the remote well site. The new and novel aspects of the ‘display window’ 32/InterACT Stimulation Viewer 32, in accordance with one aspect of the present invention, will be discussed in detail below with reference to FIG. 21.

Referring to FIGS. 14 through 20, an overview of a basic operation of an InterACT stimulation service (i.e., an ‘InterACT overview’) is illustrated. In the InterACT overview of FIGS. 14 through 20, the following steps describe in detail an internal mechanism by which data is delivered to a client in real time: (1) ‘login/challenge’ representing a ‘login’ operation, (2) ‘query’ representing querying the server, (3) ‘response catalog’ representing responses from the server, (4) ‘file select’ representing file selection, and (5) ‘file delivery’. In FIGS. 14 through 20 below, each of these steps will be discussed in detail.

In FIG. 14, a client workstation or personal computer 33 communicates with a primary server 35 via the internet 39, the primary server 35 (which is the primary server 18 of FIG. 2) communicating with a back end database 37 (which is the secondary server 22 of FIG. 2). The client, via his personal computer (PC) 33, accesses a browser in his PC 33, such as Netscape Communicator or Microsoft Internet Explorer, for the purpose of accessing the internet 39 and accessing the primary server 35. Referring to FIG. 14, when the client computer 33 communicates with the primary server 35, five steps are implemented: (1) ‘login/challenge’, (2) ‘query’, (3) ‘response catalog’, (4) ‘file select’, and (5) ‘return file and RDV applet’. When the primary server 35 communicates with a back end database 37 (a secondary server 37), step (4) representing ‘file select’ will be implemented by practicing two substeps: (4a) ‘get file’, and (4b) ‘return file’. Each of the five steps including each of the two substeps will be discussed in detail below.

In FIG. 14, the first step involves retrieving certain ‘wellbore data’ called ‘InterACT FracCAT’ data. A FracCAT data file can be downloaded from InterACT to a computer using Netscape or Microsoft Internet Explorer, inside or outside of ‘SINet’ (which is Schlumberger's Internet). The data is displayed graphically and digitally in real-time, or as historical data. The first step to retrieve the ‘wellbore data’ (called the FracCAT data file) is to log-in to the InterACT Web page on the primary server 35, using your personal computer 33 to access the internet 39:

(1) Login/Challenge

In FIG. 15, the ‘login/challenge’ step of FIG. 14 is implemented. The image illustrated in FIG. 15 shows the InterACT login page. On the InterACT login page of FIG. 15, log-in with your username and password.

(2) Query

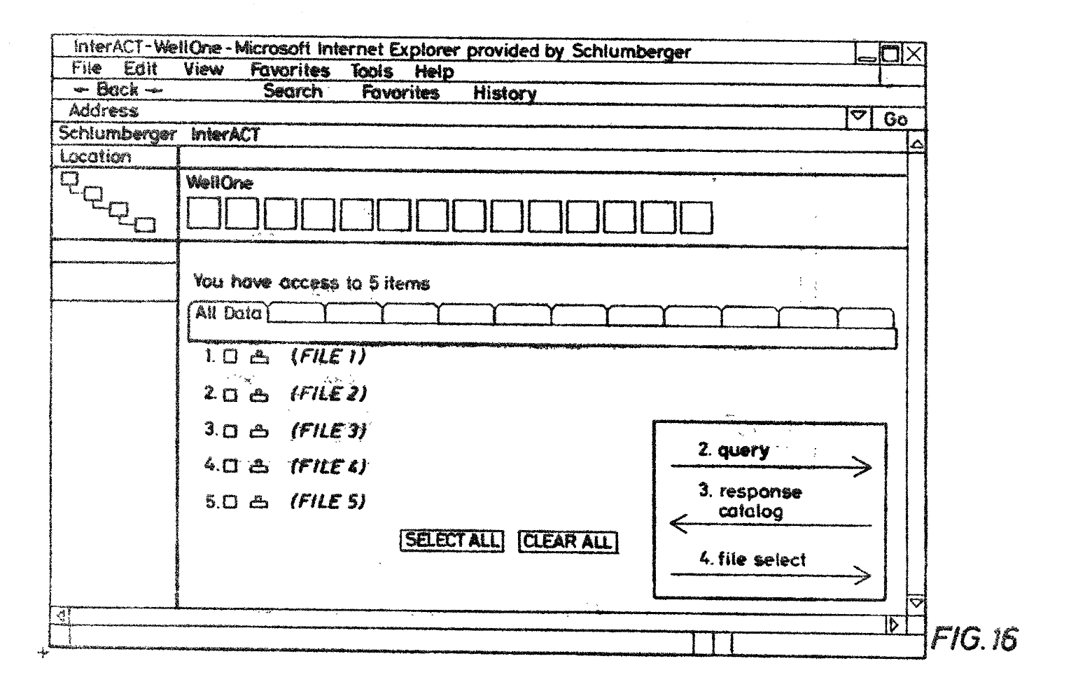

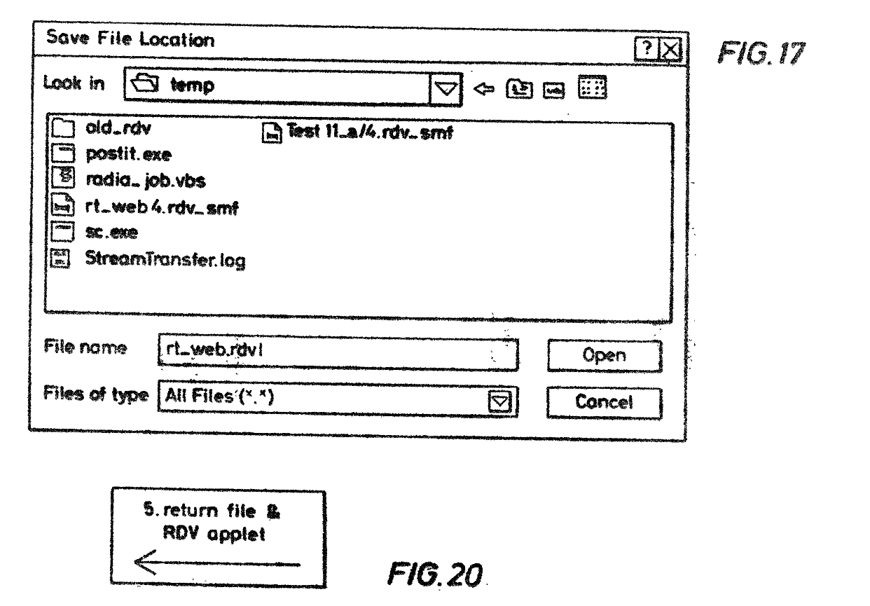

In FIG. 16, the ‘query’ step of FIG. 14 is implemented. Next, do the following:

Navigate to the Organization and Well, or Section, in FIG. 16, to which the FracCAT data file belongs. Click [symbol] to view the File Details page containing the data you want to download.

(3) Response Catalog

In FIG. 16, the ‘response catalog’ step of FIG. 14 is implemented. If the ‘wellbore data’ called the ‘FracCAT data file’ is published from the FracCAT software, [symbol] will be displayed adjacent to the data file's name.

(4) File Select,

(4a) Get File

(4b) Return File

In FIG. 16, the ‘file select’ step of FIG. 14 is implemented. In FIG. 16, click either [symbol] or [symbol] to select and download a ‘wellbore data’ file; this action implements the ‘file select’ step (4). The primary server 35 of FIG. 14 will then select the ‘wellbore data’ file, such as the ‘FracCAT data file’, that is stored in the back end database 37 (the secondary server 37). This action implements the ‘get file’ step (4a). In response to the ‘get file’ step (4a), the ‘wellbore data’ file is sent back from the secondary server 37 to the primary server 35, and this action implements the ‘return file’ step (4b).

(5) Return File and RDV Applet

In FIGS. 14 and 16, the ‘wellbore data’ file 30, such as the ‘FracCAT data file’ along with its associated ‘applet’ program 28 of FIG. 3 are both downloaded from the primary server 35 to the client's machine or workstation or personal computer 33 in FIG. 14 via the internet 39.

In FIG. 17, the “Save File Location” dialog of FIG. 17 allows the client sitting at his personal computer 33 to select a filename and a location in which to copy and store the ‘wellbore data’ file onto the client's personal computer 33 in FIG. 14.

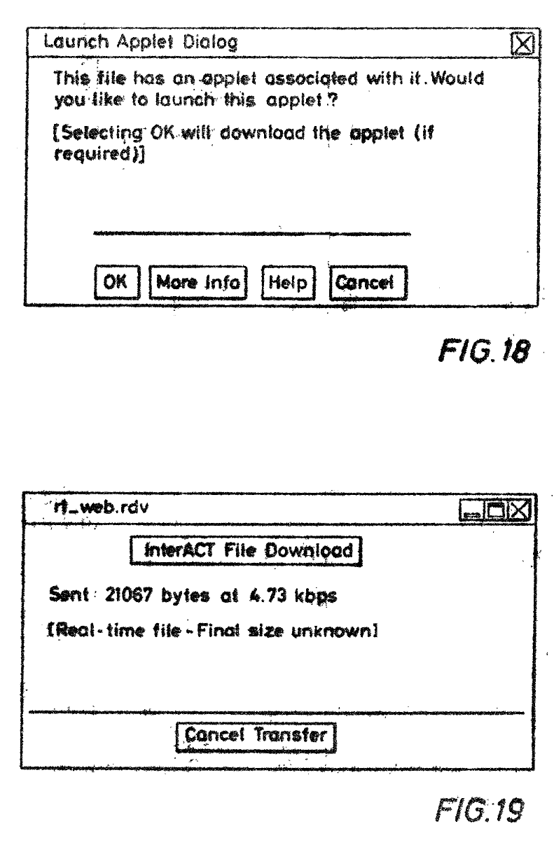

In FIG. 18, this dialog window in FIG. 18 requests the client's permission to launch or start the downloading of both the applet program 28 of FIG. 3 and its associated ‘wellbore data’ file 30. Select “OK” in FIG. 18.

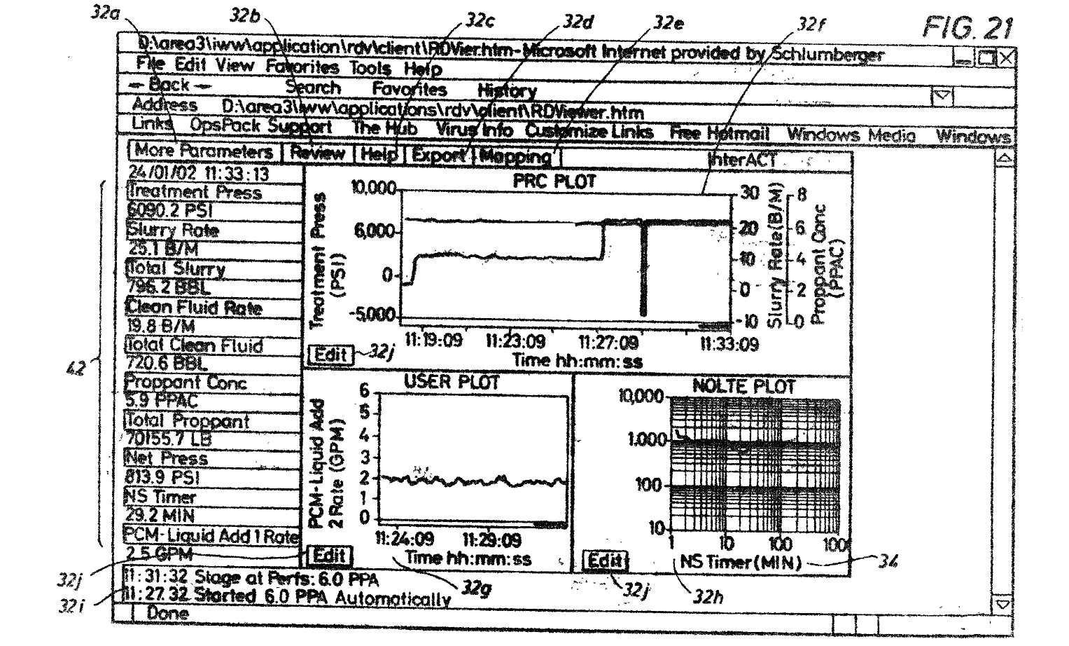

In FIG. 19, this dialog window in FIG. 19 displays the download status of your ‘applet’ program 28 and its associated ‘wellbore data’ file 30 (the FracCAT data file) from the InterACT primary server 35 to the client's workstation or personal computer 33 of FIG. 14.

In FIG. 20, the ‘return data file and RDV applet’ step (5) in FIG. 14 has been implemented.

The applet program (28 in FIG. 3) should now open and display the ‘InterACT Stimulation Viewer’ 32 of FIG. 13 which is illustrated again in FIG. 21. When the download of the applet program code 28 and its associated ‘wellbore data’ file 30 of FIG. 19 is complete, the new and novel ‘display window’/InterACT Stimulation Viewer 32 of FIGS. 13 and 21 of the present invention will be displayed on the display screen of the client's personal computer 33 of FIG. 14. The Viewer 32 of the present invention will display the ‘wellbore data’ (30 of FIG. 4) which is stored in the ‘wellbore data’ file 30, such as the FracCAT data file. The ‘wellbore data’ 30 will be displayed on the Viewer 32 in at least two forms: (1) in a ‘graphical form’ which is comprised of at least three different graphical plots, and (2) in a numerical form which is comprised of a plurality of digital information. In addition, the ‘wellbore data’, that is being displayed on the Viewer 32, can be either real-time data or historical data.

Referring to FIG. 21, a more detailed construction of the new and novel ‘display window’/InterACT Stimulation Viewer 32, in accordance with one aspect of the present invention, is illustrated. The main components of the ‘InterACT Stimulation Viewer’ 32 in FIG. 21 are as follows:

1. More Parameters 32a—The more parameters button 32a is used when more than 10 parameters are acquired and the user needs to view the parameters adjacent to the parameters being displayed.

2. Review 32b—The review button 32b is used to load historical data into plots, the historical data being loaded forms the start of the job and continues with real time data if available. The ‘Review’ 32b function that has been built into the ‘InterACT Stimulation Viewer’ 32 of FIG. 14 will allow ‘historical data’, that is contained in a real time file, to be read and displayed in the plots 32f/32g/32h of the ‘InterACT Stimulation Viewer’ 32; this ‘Review’ mechanism also allows the user to review that ‘historical data’ and, at the same time, to continue with the real time data that is being generated, in real time, at the wellsite.

3. Help 32c—The Help button 32c represents the basic help functionality for the viewer 32.

4. Export 32d—The Export button 32d will open a network socket port in the client machine and will allow the user to export the data being displayed to any local client, such as ‘FracCADE’.

5. Mapping 32e—The mapping button 32e sends the parameter name and unit to the client of the Export function.

6. PRC Plot 32f—The PRC Plot 32f displays the Treatment Pressure, Slurry Rate, and Proppant Concentration.

7. User Plot 32g—The User Plot 32g displays the parameter selected from the left-frame list of parameters.

8. Nolte-Smith Plot 32h—The Nolte-Smith Plot 32h displays Net Pressure vs. Nolte Time in a standard log-log plot.

9. Message Window 32i—The Message Window 32i, which is located below the User Plot 32g and Nolte Plot 32h displays, indicates any job messages and the time the job was logged.

10. Edit 32j—The Edit button 32j (and there are three such Edit buttons in the ‘display window 32’/InterACT Stimulation Viewer 32 in FIG. 21) is used to change the grid and axis parameters of the PRC plot 32f, the User plot 32g, and the Nolte Plot 32h.

In FIG. 21, the InterACT Stimulation Viewer 32 of FIG. 21 can be viewed by simply accessing the internet 26/39 and, when the ‘display window’/Viewer 32 is displayed on the display screen of a client's personal computer (24a, 24b, 24c, or 33), the Viewer 32 will display a plurality of digital information 42 in FIG. 21 and a plurality of graphical information 32f/32g/32h in FIG. 21 including the ‘PRC plot’ 32f, the ‘User plot’ 32g, and the ‘Nolte-Smith plot’ 32h. The PRC plot 32f is a plot of Pressure, Rate, and Concentration (or Density) and it measures the treatment pressure (in a fracturing operation), the rate at which the treatment is accomplished, and the concentration or density of the fluid that is being pumped up the hole. The User plot 32g will display each of the plurality of digital information 42 of FIG. 18 in a graphical format; that is, in the User plot 32g, each of the digital information 42 (such as treatment pressure or slurry rate or total slurry) can be displayed on the y-axis and time (t) is displayed on the x-axis. The User plot 32g can also display ‘historical’ digital information 42 as well as real-time digital information. In FIG. 13 and 21, the digital information 42 includes the following (starting from the top under element 42 in FIGS. 13 and 21): treatment pressure, slurry rate, total slurry, clean fluid rate, total clean fluid, proppant concentration, total proppant, net pressure, NS (Nolte Smith) timer (a computation used in the Nolte-Smith plot 32h), PCM liquid add 1 rate, annulus pressure (see FIG. 13), and BH (bottom hole) pressure (see FIG. 13). The Nolte-Smith plot 32h is a computation that takes into account the bottom hole pressure; the Nolte-Smith plot reveals how a reservoir is reacting to a fracture treatment, and it reveals how well a fracture treatment is being performed.

In FIG. 21, the PRC Plot 32f and the User Plot 32g of the ‘InterACT Stimulation Viewer’ 32 each automatically scroll to show the most recent ‘wellbore data’ (i.e., ‘real time’ wellbore data). A horizontal scroll bar is available. Click and drag the mouse pointer inside the plot to select an area in which to ‘zoom-in’. Right click inside the plot to ‘zoom out’, in incremental steps. In FIG. 21, the ‘NS Timer’ 34 must be a positive value to be displayed in the Nolte-Smith Plot 32h. In FIG. 21, the ‘grid color’ and ‘x-y axis’ of each plot (i.e., the PRC plot 32f, the User plot 32g, and the Nolte plot 32h) can be configured. Click the Edit button 32j inside a plot to display the dialog for these options. The ‘Chart Preferences’ dialog is similar for each plot 32f/32g/32h, with ‘Grid’ and ‘Axes’ buttons being used to display available options. The ‘Grid’ options include three ‘Color Charts’ for selecting the background, line, and border colors of each plot 32f/32g/32h. Click ‘Palette . . . ’ to make color selections and then click ‘Save’. Enable or disable the grid from this dialog window. The plot displays the new configuration immediately. Customize the grid colors using one of these three choices, and then select ‘Apply’ to display the new configuration option. “Named Colors” include 132 named colors from which to select. “Uniform Colors” include 84 colors from which to select. “Custom Colors” allows the user to type in the RGB colors or the color code, click and move the slide-bar color indicators, or click the “Lighter/Darker” buttons to select the desired color. Click “Add Color to Palette” to store the custom color. It is then available as a color option for each plot. The “Axes” options include a drop-down list to select an available axis in the plot to customize. Make the selections desired and then click ‘Save’. The plot displays the new configuration immediately. Options available include: (1) Select an interval rate, between 5 and 30 minutes, for the grid Bottom axis (x-axis), (2) Enable or disable auto-scaling, type in the Minimum, Maximum, and Step Size, if applicable, and (3) Enable or disable auto-scrolling, type in the Minimum and Maximum scroll rates.

In FIG. 21, the ‘display window’/InterACT Stimulation viewer 32 was implemented using java ‘applets’ (28 in FIG. 3), namely Java 1.1.8. This version of java was selected to achieve browser neutrality since it is the only version that runs in Microsofts's I.E 5.5 and Netscape's Navigator 4.7 virtual machines without the use of plug-ins. The applet technology allows the stimulation viewer to have a dynamic user interface within the browser by means of buttons, menus, digital displays and graphs. Once the applet (28 in FIG. 3) is downloaded to the client browser, there is no more dependency from the server except for the real time data being downloaded. The applet 28 uses multiple threads that allow it to perform simultaneous tasks at the same time, these tasks including reading data form the real time file, updating the digital displays and plots, sending data through a network port and listening to user input. The applet 28 also uses synchronization techniques on several internal buffers to accommodate for these threads operation and to avoid data corruption. The ‘display window’ 32/stimulation viewer 32 uses third party software libraries, namely, Visual Mining ‘Netcharts’ 3.7. These libraries support all the graphical output of the applet 28. ‘Netcharts’ is a set of embedded applets that can be reused by including the java classes in the applet to be developed. The ‘display window’ 32/Stimulation viewer 32 is downloaded to the client machine by means of an ASP page that will transfer the appropriate JAR or CAB to the client machine and also supply the critical client information of well and location. This ASP page will also launch the real time download applet that transfers the information from the server to the client. The security aspect (out of the sandbox) of the applet 28 is taken into account by signing the JARs and CABs that contain the Stimulation Viewer 32 with a ‘certificate’. The signing takes place when new JAR or CABs are built. The applet 28 ‘out of box’ operations are: reads disk files, writes disk files, opens network sockets, reads network sockets and transfers server files to the client machine.

A functional specification associated with the ‘InterACT Stimulation Viewer’ 32/‘display window’ 32 of FIGS. 13 and 21 is set forth below in the following paragraphs.

InterACT Stimulation Viewer 32 Specifications—Platform

The Stimulation viewer runs in Internet Explorer 5.5 and Netscape 4.7 browsers.

No additional software is required for the viewer. Latency should be kept as close as possible to 4 seconds and should not be greater than 10 seconds. The throughput of the connection between the FracCAT System and SINET may be as low as 4800 bits per second and the system should be designed to work in this low bandwidth. A file download applet will copy a file to the client machine that contains the real time data read by the Stimulation viewer 32.

Launching the Viewer

A distinct icon will appear in the InterACT user interface next to any file that can be opened in the viewer 32. Clicking on that icon will launch the viewer 32 on the user's browser, viewing the appropriate file. Only registered InterACT users will have access to this functionality. Upon startup, the viewer 32 will rapidly play through the existing data, then show the remainder in real-time. For large size files, it is unknown how much time it will take for the client to catch up with the current data. This needs to be investigated and see if it is a real issue. The InterACT real time feed should be validated for completeness. If records are incomplete or damaged, they should be discarded before being sent to the viewer 32.

Units

The viewer will do no unit conversions. The units for each parameter should be acquired from FracCAT and displayed.

Parameter Names

Names that appear in the viewer 32 should be descriptive. They should not be variable names from FracCAT. For example, we should see “Treating Pressure,” not “TR_PRESS.” This is a necessity at least for the following commonly sent parameters:

Treating pressure

Proppant concentration

Slurry Rate

Injection Rate

Bottomhole Pressure

Bottomhole Proppant Concentration

Total Bottomhole Proppant

Total Proppant

Total Slurry

Total Injected Volume

Annulus Pressure

Clean Fluid Rate

Nitrogen Rate

CO₂ Rate

Total Nitrogen

Total CO₂

It may be best to account for these names in FracCAT, rather than the viewer 32.

Viewer Components

The Web viewer will consist of several components. Each will be viewable within the browser. It may be desirable to pop up an additional browser window for display of some secondary components.

Table of Digital Displays

The table of digital displays will be organized in a column of parameter names and values including the units. Date and Time will always occupy the first row in the column.

A maximum of 10 parameters can be displayed but a button will allow the user to scroll through all the incoming parameters.

Strip Chart Plot

A Strip Chart with a scroll bar and at least 3 Y-axis will be shown. The Y-axis parameters will be defaulted to Treatment pressure, Proppant Concentration and Slurry Rate. The X-axis of the chart should display time in “hh:mm:ss” format. The scroll bar will allow the user to scroll back at most 4 hours prior to the current datapoint. All Y-axes should be autoscalable to minimize user input.

User Plot

A Strip Chart with a scroll bar will be shown. The user will be able to select which parameters to plot by selecting it from the digital display table. When a new parameter is selected it will start plotting from the time of selection. The scroll bar will allow the user to scroll back at most 4 hours prior to the current datapoint.

Message Window

There will be a window that shows the most recent job message received, and the time it was logged.

Nolte-Smith Plot

A Nolte-Smith plot will be available. This is a log/log scale plot of net pressure vs. time.

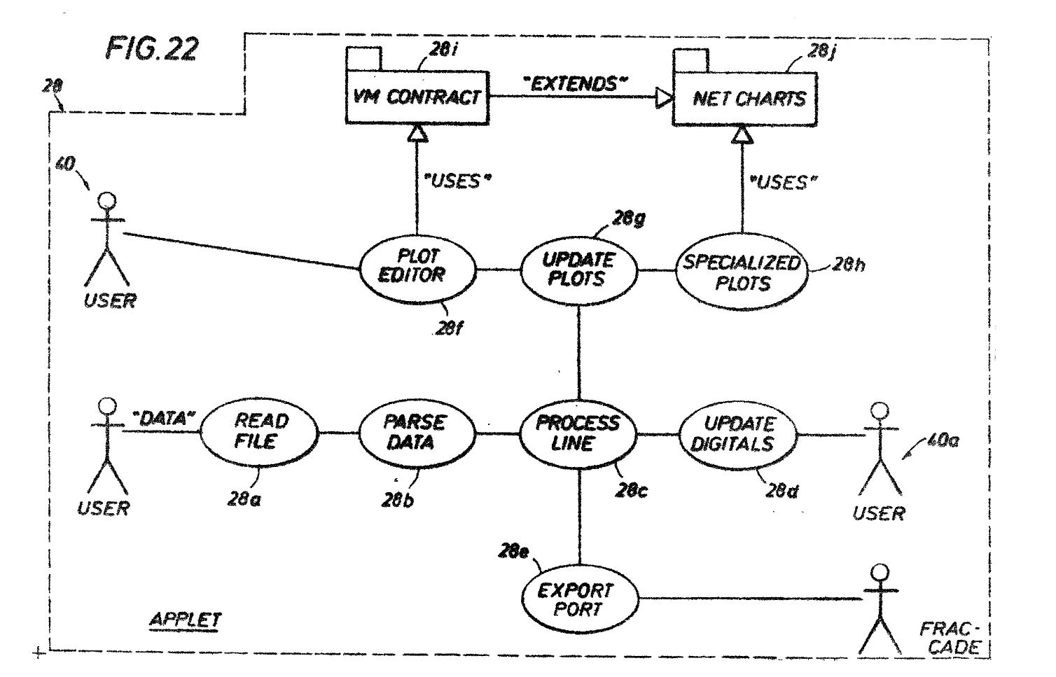

Referring to FIG. 22, a detailed flowchart of the ‘applet’ software program 28 of FIG. 3 (i.e., the “InterACT RT Applet”) is illustrated. The flowchart of the ‘applet’ software 28 includes the following modules or blocks of code, each of which will be discussed in detail in the paragraphs below: ReadFile 28a, ParseData 28b, ProcessLine 28c, UpdateDigitals 28d, ExportPort 28e, PlotEditor 28f, UpdatePlots 28g, Specialized Plots 28h, VM Contract 28i, and NetCharts 28j.

In FIG. 22, in connection with the ‘InterACT Real Time (RT) Applet’ 28 of FIG. 3, the ‘InterACT Real Time Applet’ 28 in the primary server 18/35 retrieves a data file (e.g., a ‘wellbore data’ file 30) from the secondary server 22/37 and transmits that data file, containing ‘real time’ wellbore data 30, to the client's personal computer 24a/33 via the internet 26/39 of FIGS. 11 or 14. For example, the ‘wellbore data’ file can comprise the plurality of digital information 42 illustrated in FIGS. 13 and 21. The applet 28 and the ‘wellbore data’ file 30 (of FIGS. 3 and 4) are both downloaded from the primary InterACT server 18 to the client's workstation or personal computer 24a of FIG. 11. The ‘InterACT Real Time Applet’ 28 also creates a semaphore file that is used to negotiate between reading data from the InterACT server 18 and making the data available to the stimulation viewer 32. The applet 28 in the flowchart of FIG. 22 includes two other ‘sub-applets’ which are also downloaded into the client's personal computer 24a/33 as part of the applet 28: the ‘VM Contract 28i’ sub-applet, and the ‘NetCharts 28j sub-applet’. The ‘VM Contract’ 28i and the ‘NetCharts’ 28j sub-applets can be licensed or purchased or obtained from a company by the name of:

Visual Mining, Incorporated, 15825 Shady Grove Rd, Suite 20, Rockville, Md. As shown in FIG. 12, when the downloading to the client's personal computer 24a/33 is complete, the applet 28 (including sub-applets 28i and 28j) and the associated ‘wellbore data’ 30 in the ‘wellbore data’ file 30 are all received in the ‘browser’ 19A of the client's personal computer 24a/33. That ‘browser’ 19A (e.g., either Netscape Communicator or Microsoft Internet Explorer) is a ‘virtual machine’ program code which, when executed, will also execute the applet program code 28 while simultaneously utilizing the ‘wellbore data’ inherent in the ‘wellbore data’ file 30 during the execution of the applet program code 28. The applet 28 is automatically executed when downloaded from the server 18/35 into the ‘browser’ of the client's personal computer 24a/33.

In FIG. 22, the ‘ReadFile’ module 28a will read ‘wellbore data’ from the InterACT RT Applet 28 in the form of ASCII characters. In addition, the ‘ReadFile’ module 28a will also use a ‘buffer’ to buffer the ‘wellbore data’ so that the ‘wellbore data’ can be consumed by a ‘parser’ (see ‘parse data’ module 28b) of the InterACT Stimulation Viewer 32 of FIG. 21. The ‘ReadFile’ module 28b uses ‘special techniques’ to eliminate “wave” effects that are common in internet transferred data. The ‘special techniques’ in question utilize certain so-called ‘smart buffers’ that are synchronized so that the ‘wellbore data’ can come in and out at the same time.

In connection with the ‘ParseData’ module 28b of FIG. 22, when the ‘wellbore data’ is read from the ‘ReadFile’ module 28a, the ‘wellbore data’ is then parsed, in the ‘ParseData’ module 28b, in order to build ‘lines’ that will be encoded in the data file. That is, it is necessary to determine if the ‘lines’ are a ‘header line’ or an ‘event line’ or a ‘data line’. Therefore, the ‘line’ must be constructed properly, and the ‘ParseData’ module 28b constructs that ‘line’. More particularly, in the ‘ParseData’ module 28b, the ‘line’ that is constructed is a ‘data line’ which includes both ‘a date’ and ‘data’. It is necessary to determine if that ‘data line’ is either a ‘header’ line, or an ‘event’ line, or ‘data’ line depending on the purpose for which the ‘data line’ will be used. A ‘header line’ is used to set the parameter names and units. An ‘event line’ is used to inform the user of some important event that has occurred at the wellsite. The ‘data line’ is used to feed both the ‘digitals’ (i.e., the plurality of digital information 42 in FIGS. 13 and 21) and the ‘plots’ (i.e., the PRC plot 32f or the User plot 32g or the Nolte-Smith plot 32h).

In connection with the ‘ProcessLine’ module 28c in FIG. 22, when the ‘line’ is constructed and we know its type (header or event or data), we can extract: header information, which includes units and parameter names; event information, which is a time stamp; and some text, which describes the event and what that event is about, or data, which is a time stamp plus a set of values which are mapped to the parameters.

In connection with the ‘UpdatePlots’ module 28g and the ‘specialized plots’ module 28h, the ‘Update Plots’ module 28g and ‘specialized plots’ module 28h will package the ‘wellbore data’ from the ‘Processline’ module 28 into a form that can be consumed by the ‘Netchart’ plots 28j. More particularly, the processed data from the ProcessLine module 28c is sent to the Specialized Plots 28h which are built with the Netcharts module 28j. In connection with the ‘specialized plots’ module 28h, this module will transform the data into a format that is readable by the ‘Netcharts’ module 28j. From here on, the ‘Netcharts’ module 28j is taking care of the graphical representation in the plots 32f, 32g, and 32h of the InterACT Stimulation Viewer 32 in FIG. 21.

In connection with the ‘Netcharts’ module 28j, these are charts (that are used as strip charts) that have a 3 hour view range with a 15 minute window and are updated every few seconds. The mode of operation of the y-axis is to autoscale by default and give the user the capability to modify the scale with the chart editor.

In connection with the ‘PlotEditor’ module 28f, the ‘PlotEditor’ 28f allows the user 40 manipulate or use the ‘PlotEditor’ 28f to change the ‘Netcharts’ 28j; that is, to open the charts and change the axes or change the grids or the scales.

In connection with the ‘VM Contract’ module 28i and the ‘Netcharts’ module 28j, these modules 28i and 28j comprise a plurality of commercial libraries that have been licensed or purchased from Visual Mining, Incorporated, 15825 Shady Grove Rd, Suite 20, Rockville, Md. The ‘VM Contract’ module 28i is an applet that allows us to use the ‘PlotEditor’ 28f (a chart editor). The ‘NetCharts’ module 28j contains a collection of predefined charts. The ‘Netcharts’ module 28j, which is embedded in the applet 28 of FIG. 3, generates the three graphical plots that are presented on the InterACT Stimulation Viewer 32 in FIG. 18; that is, the PRC plot 32f, the User plot 32g, and the Nolte-Smith plot 32h. However, the remaining portion of the applet 28 of FIG. 3 (not including the Netcharts module 28j) produces the overall border areas on the InterACT Stimulation Viewer 32 in FIG. 21 (not including the plots which are produced by Netcharts 28j).

In connection with the ‘Update digitals’ module 28d, when the ProcessLine module 28c generates ‘processed data’, that ‘processed data’ can now be used to update the ‘digital information’ which forms the ‘plurality of digital information’ 42 in FIGS. 13 and 21, namely: treatment pressure, slurry rate, total slurry, clean fluid rate, total clean fluid, proppant concentration, total proppant, net pressure, NS (Nolte Smith) timer (a computation used in the Nolte-Smith plot 32h), PCM liquid add 1 rate, annulus pressure (see FIG. 13), and BH (bottom hole) pressure (see FIG. 13). Therefore, the ‘Update digitals’ module 28d will update the ‘plurality of digital information’ 42 on the InterACT Stimulation Viewer 32 of FIGS. 13 and 21 of the present invention. A user 40A will actually see the updated ‘plurality of digital information’ 42 on the Viewer 32.

In connection with the ‘ExportPort’ module 28e, the ‘wellbore data’ which was processed via the ‘ProcessLine’ module 28c and which flows through the ‘InterACT Stimulation Viewer’ 32 of FIG. 21 can now be exported to another application called “FracCADE”. This ‘wellbore data’ is in the form of ASCII characters, the ‘wellbore data’ being consumed by any applications that can read a ‘network socket’ on the client's personal computer or workstation (24a or 24b or 24c of FIG. 2).

The ‘Applet’ software 28 of FIG. 3 is set forth in the attached computer program software listing, as follows:

Computer Program Listing

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. A program storage device readable by a machine, tangibly embodying a program of instructions executable by the machine, to perform method steps for generating and displaying a display window depicting real time wellbore data on a display screen of said machine in response to said real time wellbore data, said program of instructions including an applet software set of instructions, said method steps comprising:
(a) reading said real time wellbore data and executing said applet software set of instructions using said real time wellbore data during the execution of said applet software set of instructions; and
(b) in response to the executing step (a), generating said display window on said display screen of said machine and displaying said real time wellbore data in said display window, the step of displaying said real time wellbore data in said display window including the steps of,
displaying a plurality of digital information in said display window, said plurality of digital information relating to said real time wellbore data, and
displaying graphical information in said display window, said graphical information relating to said real time wellbore data.

2. The program storage device of claim 1, wherein said program of instructions further include a browser software set of instructions, and wherein the reading step (a) comprises the steps of:
reading said real time wellbore data, and
executing said browser software set of instructions and said applet software set of instructions while using said real time wellbore data during the execution of said browser software and said applet software set of instructions.

3. The program storage device of claim 1, wherein said plurality of digital information is selected from a group consisting of: treatment pressure, slurry rate, total slurry, clean fluid rate, total clean fluid, proppant concentration, total proppant, net pressure, NS (Nolte Smith) timer, PCM liquid add 1 rate, annulus pressure, and BH (bottom hole) pressure.

4. The program storage device of claim 3, wherein said graphical information comprises a pressure-rate-concentration (PRC) plot.

5. The program storage device of claim 4, wherein said graphical information comprises a User plot, said User plot being a plot of one of said plurality of digital information versus time.

6. The program storage device of claim 5, wherein said graphical information comprises a Nolte-Smith plot.

7. The program storage device of claim 2, wherein said plurality of digital information is selected from a group consisting of: treatment pressure, slurry rate, total slurry, clean fluid rate, total clean fluid, proppant concentration, total proppant, net pressure, NS (Nolte Smith) timer, PCM liquid add 1 rate, annulus pressure, and BH (bottom hole) pressure.

8. The program storage device of claim 7, wherein said graphical information comprises a pressure-rate-concentration (PRC) plot.

9. The program storage device of claim 8, wherein said graphical information comprises a User plot, said User plot being a plot of one of said plurality of digital information versus time.

10. The program storage device of claim 9, wherein said graphical information comprises a Nolte-Smith plot.

11. A computer system adapted to receive a set of real time wellbore data from another source, said real time wellbore data being received by said computer system approximately simultaneously with a generation of the wellbore data at a well site, comprising:
a memory, said memory storing an applet software set of instructions, said applet software set of instructions adapted to be executed by a processor in conjunction with said set of real time wellbore data, said applet software set of instructions, when executed by said processor in conjunction with said set of real time wellbore data, generating a display window on a display screen, said display window including,
a plurality of digital information illustrating at least some of said real time wellbore data, and
a set of graphical information illustrating at least some of said real time wellbore data.

12. The computer system of claim 11, wherein said memory stores a browser software set of instructions and an applet software set of instructions, said browser software set of instructions and said applet software set of instructions adapted to be executed by said processor in conjunction with said set of real time wellbore data, said browser software set of instructions and said applet software set of instructions, when executed by said processor in conjunction with said set of real time wellbore data, generating said display window on said display screen.

13. The computer system of claim 11, wherein said plurality of digital information comprises treatment pressure.

14. The computer system of claim 11, wherein said plurality of digital information comprises slurry rate.

15. The computer system of claim 11, wherein said plurality of digital information comprises total slurry.

16. The computer system of claim 11, wherein said plurality of digital information comprises clean fluid rate.

17. The computer system of claim 11, wherein said plurality of digital information comprises total clean fluid.

18. The computer system of claim 11, wherein said plurality of digital information comprises proppant concentration.

19. The computer system of claim 11, wherein said plurality of digital information comprises total proppant.

20. The computer system of claim 11, wherein said plurality of digital information comprises net pressure.

21. The computer system of claim 11, wherein said plurality of digital information comprises NS (Nolte Smith) timer.

22. The computer system of claim 11, wherein said plurality of digital information comprises PCM liquid add 1 rate.

23. The computer system of claim 11, wherein said plurality of digital information comprises annulus pressure.

24. The computer system of claim 11, wherein said plurality of digital information comprises BH (bottom hole) pressure.

25. The computer system of claim 11 wherein said set of graphical information comprises a pressure-rate-concentration (PRC) plot.

26. The computer system of claim 11 wherein said set of graphical information comprises a User plot, said User plot being a plot of one of said plurality of digital information versus time.

27. The computer system of claim 11 wherein said set of graphical information comprises a Nolte-Smith plot.

28. The computer system of claim 12, wherein said plurality of digital information comprises treatment pressure.

29. The computer system of claim 12, wherein said plurality of digital information comprises slurry rate.

30. The computer system of claim 12, wherein said plurality of digital information comprises total slurry.

31. The computer system of claim 12, wherein said plurality of digital information comprises clean fluid rate.

32. The computer system of claim 12, wherein said plurality of digital information comprises total clean fluid.

33. The computer system of claim 12, wherein said plurality of digital information comprises proppant concentration.

34. The computer system of claim 12, wherein said plurality of digital information comprises total proppant.

35. The computer system of claim 12, wherein said plurality of digital information comprises net pressure.

36. The computer system of claim 12, wherein said plurality of digital information comprises NS (Nolte Smith) timer.

37. The computer system of claim 12, wherein said plurality of digital information comprises PCM liquid add 1 rate.

38. The computer system of claim 12, wherein said plurality of digital information comprises annulus pressure.

39. The computer system of claim 12, wherein said plurality of digital information comprises BH (bottom hole) pressure.

40. The computer system of claim 12 wherein said set of graphical information comprises a pressure-rate-concentration (PRC) plot.

41. The computer system of claim 12 wherein said set of graphical information comprises a User plot, said User plot being a plot of one of said plurality of digital information versus time.

42. The computer system of claim 12 wherein said set of graphical information comprises a Nolte-Smith plot.

43. A method for generating a display of real time wellbore information, an applet program being stored, comprising the steps of:
(a) receiving real time wellbore information from a remote well site and storing said real time wellbore information in another source;
(b) receiving a first request for a catalog of information;
(c) transmitting said catalog of information;
(d) receiving a second request associated with one entry in said catalog of information, said one entry in said catalog pertaining to said real time wellbore information stored in said another source;
(e) retrieving said real time wellbore information from said another source and retrieving the stored applet program;
(f) associating said applet program with said real time wellbore information;
(g) executing said applet program while using said real time wellbore information during the executing step (g); and
(h) in response to the executing step (g), generating said display of real time wellbore information, said display of real time wellbore information including one or more data presented in a digital format relating to said real time wellbore information and one or more data presented in a graphical format relating to said real time wellbore information.

44. The method of claim 43, wherein said one or more data presented in a digital format relating to said real time wellbore information is selected from a group consisting of: treatment pressure, slurry rate, total slurry, clean fluid rate, total clean fluid, proppant concentration, total proppant, net pressure, NS (Nolte Smith) timer, PCM liquid add 1 rate, annulus pressure, and BH (bottom hole) pressure.

45. The method of claim 44, wherein said one or more data presented in a graphical format relating to said real time wellbore information comprises a pressure-rate-concentration (PRC) plot.

46. The method of claim 45, wherein said one or more data presented in a graphical format relating to said real time wellbore information comprises a User plot, said User plot being a plot of one of said plurality of digital information versus time.

47. The method of claim 46, wherein said one or more data presented in a graphical format relating to said real time wellbore information comprises a Nolte-Smith plot.

48. A server adapted for receiving real time wellbore information from a remote well site, comprising:
a first processor adapted to receive said real time wellbore information from said remote well site and adapted to transmit said real time wellbore information to a second processor of another computer system, said another computer system having a display screen; and
a memory storing an applet program, said applet program stored in said memory having a particular structural characteristic, said particular structural characteristic of said applet program stored in said memory of said server being selected such that:
when said applet program stored in said server is executed by said second processor of said another computer system in conjunction with said real time wellbore information, a display window viewer is displayed on said display screen of said another computer system, said display window viewer displaying said wellbore information from said remote well site, in real time, approximately simultaneously with a generation of said wellbore information at said remote well site.

49. The server of claim 48, wherein said display window viewer includes a digital information format and a graphical information format, said digital information format and said graphical information format each displaying said wellbore information, in real time, approximately simultaneously with a generation of said wellbore information at said remote well site.

50. The server of claim 49, wherein said wellbore information displayed in real time via said digital information format is selected from a group consisting of: treatment pressure, slurry rate, total slurry, clean fluid rate, total clean fluid, proppant concentration, total proppant, net pressure, NS (Nolte Smith) timer, PCM liquid add 1 rate, annulus pressure, and BH (bottom hole) pressure.

51. The server of claim 50, wherein said wellbore information displayed in real time via said graphical information format comprises a pressure-rate-concentration (PRC) plot.

52. The server of claim 51, wherein said wellbore information displayed in real time via said graphical information format comprises a User plot, said User plot being a plot of one of said plurality of digital information versus time.

53. The server of claim 52, wherein said wellbore information displayed in real time via said graphical information format comprises a Nolte-Smith plot.
